(19) United States
(12) Patent Application Publication
(10) Pub. No.: US 2008/0025167 A1
(43) Pub. Date: Jan. 31, 2008

(54) CALIBRATION APPARATUS AND RELATED METHOD FOR SERVO SYSTEM OF OPTICAL DISC DRIVE

(76) Inventor: You-yan Wu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/782,641

(22) Filed: Jul. 25, 2007

(30) Foreign Application Priority Data
Jul. 26, 2006 (TW) 095127299

(51) Int. Cl. G11B 7/00

(52) U.S. Cl. 369/44.35

(57) ABSTRACT

A calibration apparatus for calibrating a servo loop gain of an optical disc drive is disclosed. The calibration apparatus includes an estimation unit, a decision unit, and a gain control unit. The estimation unit is coupled to a servo signal for estimating a signal amplitude of the servo signal to generate a signal amplitude estimation value; the decision unit coupled to the estimation unit generates a gain control signal according to the signal amplitude estimation value; and the gain control unit coupled to the decision unit adjusts the servo loop gain according to the gain control signal.

### BACKGROUND OF THE INVENTION

1. Field of the Invention

The present invention relates to an optical storage apparatus, and more particularly, to calibration apparatus and method for calibrating a servo loop gain of an optical disc drive.

2. Description of the Prior Art

An optical disc drive is a popular data storage device nowadays. When accessing (i.e. reading or writing) data on an optical disc, a servo loop system of an optical disc drive generates a servo signal, such as a tracking error (TE) signal and a focusing error (FE) signal, to perform servo calibration, so that a pick-up head of the optical disc drive may read or write data efficiently.

Please refer to FIG. 1. FIG. 1 is a functional block diagram of a conventional optical disc drive 100. The optical disc drive 100 comprises an optical pick-up unit 102 for accessing an optical disc 101, an analog-to-digital converter 104, an adder 105, an equalizer 106, a digital-to-analog converter 108, a servo controller 110, an actuating unit 112, and a calibration apparatus 114, where the calibration apparatus 114 comprises a disturbance signal generator 116, a band-pass filter 118, a phase difference comparator 120, and a gain adjuster 122. Generally speaking, in the optical disc drive 100, a close loop composed of the optical pick-up unit 102, the analog-to-digital converter 104, the equalizer 106, the digital-to-analog converter 108, the servo controller 110, the actuating unit 112, and the gain adjuster 122 can be referred to as a servo loop. Functions and operations of the components within the servo loop are well known in the art, and thus omitted here. The optical disc drive 100 derives an optimal value of the tracking error signal or the focusing error signal by adjusting a servo loop gain of the servo loop, where the phase difference comparator 120 compares the phase of a disturbance signal outputted from the disturbance signal generator 116 with the phase of a feedback signal derived from processing the disturbance signal by utilizing the servo loop (that is, the output signal of the band-pass filter 118), to decide whether to increase or decrease the value of the servo loop gain. However, there are some shortcomings of the mechanism implemented by comparing the phases and adjusting the servo loop gain according to the phase difference. For example, because of the relation between the phase difference and the servo loop gain is unknown, the system could not precisely decide how to adjust the gain value according to the phase difference. In addition, the gain adjustment precision varies in accordance with the sampling frequency of the disturbance signal generated by the disturbance signal generator 116. That is, at the same sampling frequency, the disturbance signal with higher frequency has lower resolution of the phase difference.

### SUMMARY OF THE INVENTION

It is an objective of the present invention to provide calibration apparatuses and related methods for calibrating a servo loop gain of an optical disc drive by signal amplitude estimation so as to get a better performance in servo loop calibration.

According to one embodiment of the present invention, a calibration apparatus for calibrating a servo loop gain of an optical disc drive and a related method are disclosed. The calibration apparatus comprises an estimation unit, a decision unit, and a gain control unit. The estimation unit, receiving a servo signal, is utilized for estimating an amplitude of the servo signal to generate an estimation signal. The decision unit, which is coupled to the estimation unit, is utilized for generating a gain control signal according to the estimation signal. The gain control unit, which is coupled to the decision unit, is utilized for adjusting the servo loop gain according to the gain control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a conventional optical disc drive.

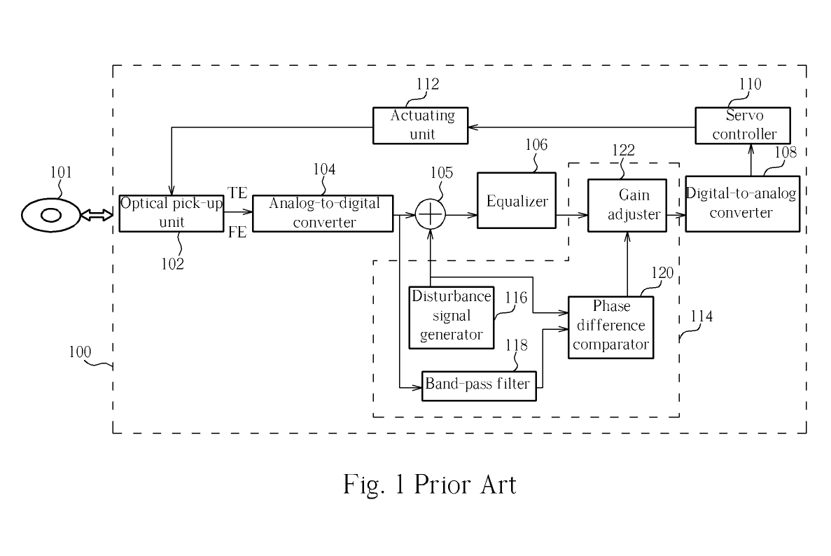

FIG. 2 is a functional block diagram of an optical disc drive according to a first embodiment of the present invention.

FIG. 3 is a bode diagram of a close loop system in an optical disc drive servo system according to one embodiment of the present invention.

FIG. 4 illustrates the relation between a signal amplitude estimation value and a servo loop gain.

### DETAILED DESCRIPTION

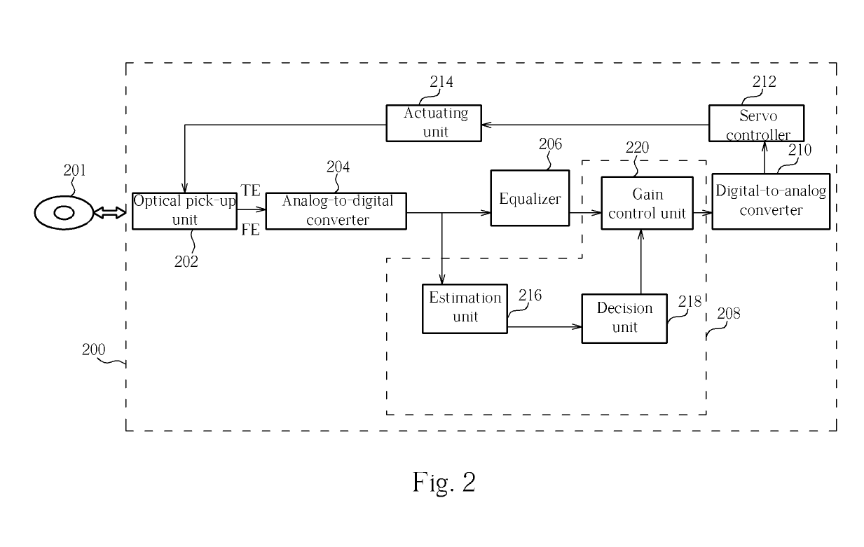

Please refer to FIG. 2. FIG. 2 is a functional block diagram of an optical disc drive 200 according to a first embodiment of the present invention. As shown in FIG. 2, the optical disc drive 200 comprises an optical pick-up unit 202, an analog-to-digital converter 204, an equalizer 206, a calibration apparatus 208, a digital-to-analog converter 210, a servo controller 212, and an actuating unit 214. In this embodiment, the calibration apparatus 208 operates in digital domain, and comprises an estimation unit 216, a decision unit 218, and a gain control unit 220. First, the optical pick-up unit 202 generates a servo signal (which can be a tracking error signal or a focusing error signal in this embodiment) when accessing the optical disc 201, and the servo signal is digitized by the analog-to-digital converter 204 and equalized by the equalizer 206 to eliminate the interference from noises, and then the gain control unit 220 adjusts the servo signal to control the gain value of the servo signal, in order to decrease the tracking error and focusing error. After the digital-to-analog converter 210 performs digital-to-analog conversion on the servo signal, the servo controller 212 adjusts the original servo signal according to the servo signal's gain value that has been adjusted by the gain control unit 220, and outputs a servo control signal to the actuating unit 214. Therefore, the actuating unit 214 adjusts the optical pick-up unit 202 according to the servo control signal. Generally speaking, the closed loop system composed of the above-mentioned components is referred to as a servo loop, and the optical disc drive 200 controls the whole operation of the servo system by utilizing the servo loop.

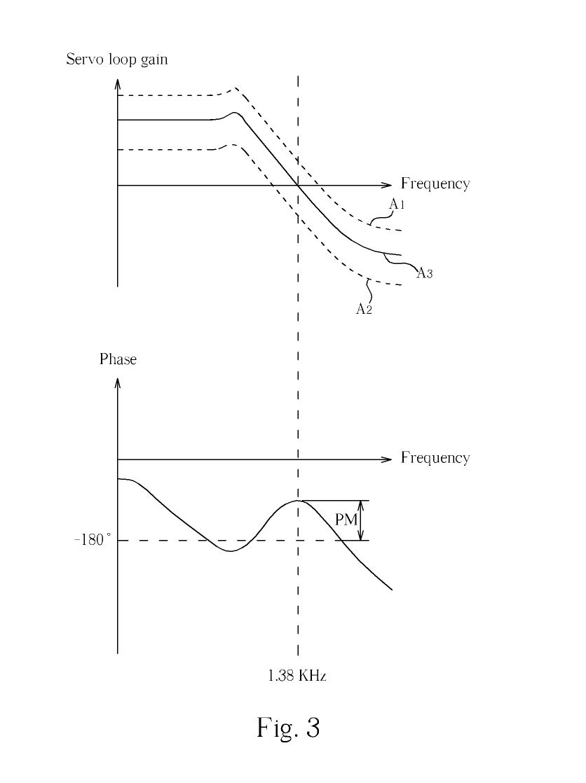

Please refer to FIG. 3, FIG. 3 is a bode diagram of the closed loop system in an optical disc drive servo system such as that shown in FIG. 2 according to one embodiment of the present invention. As shown in FIG. 3, at a predetermined frequency (e.g., 1.38 kHz), it is clear that when the servo loop gain is set at an optimal value thereof, the signal amplitude of the servo signal (e.g., the tracking error signal or the focusing error signal) will approaches zero (e.g., the situation illustrated with the characteristic curve A₃ as shown in FIG. 3) and the optical disc drive servo system has an optimal phase margin in this situation. However, if the servo loop gain deviates from the optimal value (e.g., the situations illustrated with the characteristic curves A₁ and A₂ as shown in FIG. 3), the optical disc system would have a phase margin out of a preferred range around the optimal phase margin, the calibration apparatus 208 in the embodiment of the present invention will search the optimal gain setting according to the characteristic mentioned above.

In the preferred embodiment, the estimation unit 216 is coupled to the servo signal outputted from the analog-to-digital converter 204 (i.e., the digitized servo signal), and is utilized for measuring the peak-to-peak value of the servo signal and generating the corresponding signal amplitude estimation value S_{d} according to the peak-to-peak value of the servo signal and further outputting the signal amplitude estimation value S_{d} to the decision unit 218. However, not only measuring the peak-to-peak value to estimate the signal amplitude, but also measuring the power value or average amplitude value to generate the signal amplitude estimation value S_{d} can be utilized for implementation according to various embodiments of the present invention. According to the signal amplitude estimation value S_{d} and a predetermined signal amplitude value Sᵣ (or a threshold value), the decision unit 218 compares the two values S_{d} with Sᵣ and further determines whether a difference between the two values S_{d} and Sᵣ falls within a predetermined range. If this difference has not fallen within the predetermined range (no matter whether the signal amplitude estimation value S_{d} is greater or smaller than the predetermined signal amplitude value Sᵣ), the decision unit 218 outputs a gain control signal S_{c} to the gain control unit 220, and the gain control unit 220 adjusts the servo loop gain according to the gain control signal S_{c} till the difference between the signal amplitude estimation value S_{d} and the predetermined signal amplitude value Sᵣ falls within the predetermined range. It is noticed that the predetermined signal amplitude value Sᵣ could be a programmable threshold value. However, in another embodiment of the present invention, the decision unit 218 can directly compare the difference between the two values S_{d} and S_{c} to output the gain control signal S_{c}, and the gain control unit 220 adjusts the servo loop gain according to the gain control signal S_{c}, and the gain control unit 220 does not stop adjusting the servo loop gain until the signal amplitude estimation value S_{d} is smaller than the predetermined signal amplitude value Sᵣ. In addition, please note that, the predetermined signal amplitude value Sᵣ can be generated according to the tracking error signal or the focusing error signal.

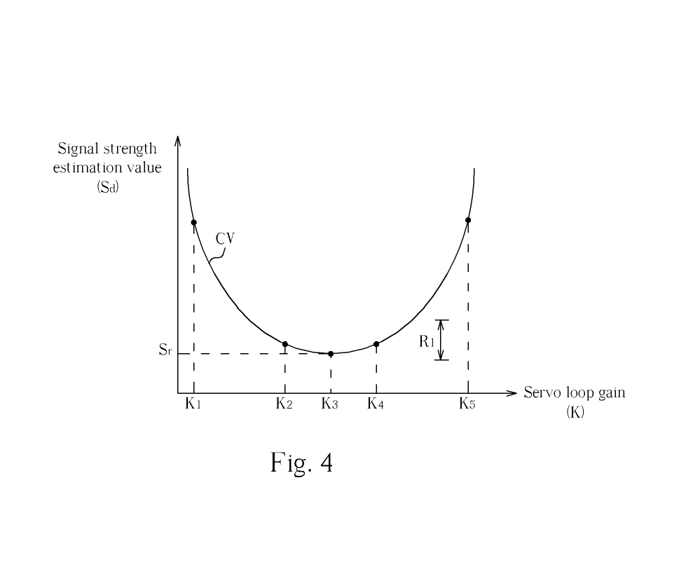

Please refer to FIG. 4, FIG. 4 illustrates the relation between the signal amplitude estimation value S_{d} and the servo loop gain K. Please note that, as mentioned before, the servo signal can be the tracking error signal or the focusing error signal. Therefore, if the servo signal under processing is the tracking error signal, the signal amplitude estimation value S_{d} is utilized for representing the signal amplitude of the tracking error signal. Besides, if the servo signal under processing is the focusing error signal, the signal amplitude value S_{d} is utilized for representing the signal amplitude of the focusing error signal. As shown in FIG. 4, the characteristic curve CV illustrates the relation between the signal amplitude estimation value S_{d} and the servo loop gain K in an ideal case of the optical disc drive 200. When the servo loop gain K is equal to K₃, the signal amplitude estimation value S_{d} reaches the minimum value. That is if the signal amplitude estimation value S_{d} is equal to the predetermined signal amplitude value Sᵣ, K₃ is the best setting value of servo loop gain K. However, in a real case of the optical disc drive 200, the real characteristic curve representing the relation between the signal amplitude estimation value S_{d} and the servo loop gain K may slightly deviate from the ideal characteristic curve CV shown in FIG. 4. Consequently, in this embodiment, a predetermined range R₁ (i.e., a tolerance range) is provided and set as shown in FIG. 4, so when the difference between the signal amplitude estimation value S_{d} and the predetermined signal amplitude value Sᵣ falls within the predetermined range R₁, the current servo loop gain can be determined as the servo loop gain wanted. For example, the servo loop gain K being set as K₂ or K₄ can be determined as the servo loop gain wanted. On the contrary, if the difference between the signal amplitude estimation value S_{d} and the predetermined signal amplitude value Sᵣ falls outside the predetermined range R₁, for example, the servo loop gain K is set as K₁ or K₅, the decision unit 218 utilizes the gain control signal S_{c} to increase or decrease the current servo loop gain, in order to decrease the difference between the signal amplitude estimation value S_{d} and the predetermined signal amplitude value Sᵣ. Additionally, according to the operations of adjusting the servo loop gain as mentioned above, it is understandable that with the predetermined signal amplitude value Sᵣ and the signal amplitude estimation value S_{d} being utilized, whether the appropriate servo loop gain setting is approached can be determined according to the difference between the two values Sᵣ and S_{d}.

However, in other embodiments of the present invention, the decision unit 218 can also find the appropriate servo loop gain setting without utilizing the predetermined signal amplitude value Sᵣ. The decision unit 218 decides the servo loop gain control signal S_{c} by determining whether the signal amplitude estimation value S_{d} approaches its extreme value, so as to control the gain control unit 220 to not stop adjusting the servo loop gain until the signal amplitude estimation value S_{d} approaches its extreme value (i.e., the signal amplitude estimation value S_{d} corresponding to the servo loop gain K₃ shown in FIG. 4). For example, if the servo loop gain K is increased from K₁ shown in FIG. 4 with a gain adjusting value, the signal amplitude estimation value S_{d} decreases. In addition, if the servo loop gain K is adjusted from K₂ to K₄ and passes through the value K₃ where the extreme value of the signal amplitude estimation value S_{d} locates, the signal amplitude estimation value S_{d} does not decrease while the servo loop gain K is increased. Therefore, the decision unit 218 can decide that the signal amplitude estimation value S_{d} may reach its extreme value when the servo loop gain K falls within the range [K₂, K₄]. Thus, the current setting value of K, i.e. K₄, can be directly utilized as the servo loop gain wanted, or according to the operating mechanism mentioned above, a smaller value of the gain adjusting value can be further utilized for slightly decreasing the servo loop gain K from K₄ shown in FIG. 4 to another value so that the servo loop gain K passes through the value K₃ where the extreme value of the signal amplitude estimation value S_{d} locates. By repeating the above steps with gradually decreased values of the gain adjusting value, an optimized value of the servo loop gain that is closer to the optimal servo loop gain K₃ can be found.

Additionally, regarding the operation of searching the servo loop gain without utilizing the predetermined signal amplitude value Sᵣ, other decision mechanism can be applied to other embodiments of the present invention. For example, the decision unit 218 adjusts the servo loop gain according to the slope variation of the signal amplitude estimation value S_{d}. In a situation where the current servo loop gain K is K₁, the corresponding slope is negative. When the servo loop gain K is increased from K₁ with a gain adjusting value, the absolute value of the slope decreases. When the servo loop gain K is adjusted from K₂ to K₄ and passes through the value K₃ where the extreme value of the signal amplitude estimation value S_{d} locates, the absolute value of the slope does not decrease while the servo loop gain K is increased. Therefore, the decision unit 218 can decide that the signal amplitude estimation value S_{d} may reach its extreme value when the servo loop gain K falls within the range [K₂, K₄]. Thus, the current setting value of K, i.e. K₄, can be directly utilized as the servo loop gain wanted, or according to the operating mechanism mentioned above, a smaller value of the gain adjusting value can be further utilized for slightly decreasing the servo loop gain K from K₄ shown in FIG. 4 to another value so that the servo loop gain K passes through the value K₃ where the extreme value of the signal amplitude estimation value S_{d} locates. By repeating the above steps with gradually decreased values of the gain adjusting value, an optimized value of the servo loop gain that is closer to the optimal servo loop gain K₃ can be found.

Please note that, besides the mechanism of searching the servo loop gain as mentioned above, any extreme value searching mechanism of the prior art can be applied to the decision unit 218 according to other embodiments of the present invention, in order to decide how to adjust the gain control signal S_{c} and set an appropriate value of the servo loop gain to the gain control unit.

Those skilled in the art will readily observe that numerous modifications and alterations of the device and method may be made while retaining the teachings of the invention.

What is claimed is:

1. A calibration apparatus for calibrating a servo loop gain of an optical disc drive, comprising:
an estimation unit for estimating a signal amplitude of a servo signal to generate a signal amplitude estimation value;
a decision unit, coupled to the estimation unit, for generating a gain control signal according to the signal amplitude estimation value; and
a gain control unit, coupled to the decision unit, for adjusting the servo loop gain according to the gain control signal;
wherein the signal amplitude estimation value is corresponding to the servo loop gain.

2. The calibration apparatus of claim 1, wherein the estimation unit estimates a peak-to-peak value of the servo signal to generate the signal amplitude estimation value.

3. The calibration apparatus of claim 1, wherein the servo signal is a tracking error signal or a focusing error signal.

4. The calibration apparatus of claim 1, further comprising:
an analog-to-digital converter for performing analog-to-digital conversion on the servo signal; and
a digital-to-analog converter for performing digital-to-analog conversion on an output signal of the gain control unit.

5. The calibration apparatus of claim 1, wherein the decision unit generates the gain control signal by comparing the signal amplitude estimation value with a predetermined threshold value.

6. The calibration apparatus of claim 5, wherein the predetermined threshold value is a programmable threshold value.

7. The calibration apparatus of claim 1, wherein if the signal amplitude estimation value is smaller than a predetermined threshold value, the gain control unit stops adjusting the servo loop gain.

8. The calibration apparatus of claim 1, wherein the decision unit generates the gain control signal according to the slope between the signal amplitude estimation value and the servo loop gain.

9. The calibration apparatus of claim 2, further comprising:
an analog-to-digital converter for performing analog-to-digital conversion on the servo signal; and
a digital-to-analog converter for performing digital-to-analog conversion on an output signal of the gain control unit.

10. The calibration apparatus of claim 9, wherein if the signal amplitude estimation value is smaller than a predetermined threshold value, the gain control unit stops adjusting the servo loop gain.

11. The calibration apparatus of claim 10, wherein the estimation unit estimates a peak-to-peak value of the servo signal to generate the signal amplitude estimation value.

12. The calibration apparatus of claim 11, wherein the servo signal is a tracking error signal or a focusing error signal.

13. The calibration apparatus of claim 12, wherein the decision unit generates the gain control signal according to the slope relation between the signal amplitude estimation value and the servo loop gain.

14. A calibration method for calibrating a servo loop gain of an optical disc drive, comprising:
estimating a signal amplitude of a servo signal to generate a signal amplitude estimation value;
comparing the signal amplitude estimation value with a predetermined threshold value to generate a gain control signal; and
adjusting the servo loop gain according to the gain control signal.

15. The calibration method of claim 14, wherein the step of estimating the signal amplitude of the servo signal further comprises:
estimating a peak-to-peak value of the servo signal to generate the signal amplitude estimation value.

16. The calibration method of claim 14, wherein the servo signal is a tracking error signal or a focusing error signal.

17. The calibration method of claim 14, wherein the servo signal is a digital servo signal generated from analog-to-digital conversion.

18. The calibration method of claim 14, further comprising:
if the signal amplitude estimation value is smaller than the predetermined signal amplitude value, stopping adjusting the servo loop gain.

19. The calibration apparatus of claim 1, wherein the gain control signal is generated according to the slope between the signal amplitude estimation value and the servo loop gain.

20. The calibration method of claim 14, the predetermined threshold value is a programmable threshold value.
